(19) United States
(12) Patent Application Publication
(10) Pub. No.: US 2020/0121432 A1
(43) Pub. Date: Apr. 23, 2020

(54) Chronic Wound Management Apparatus For Localized Medication Delivery To Infected Periodontal Tissues

(71) Applicant: Perio Protect LLC, St. Louis, MO (US)

(72) Inventor: Duane C. KELLER, St. Louis, MO (US)

(21) Appl. No.: 16/661,790

(22) Filed: Oct. 23, 2019

Related U.S. Application Data
(60) Provisional application No. 62/749,312, filed on Oct. 23, 2018.

(51) Int. Cl. A61C 19/06

(52) U.S. Cl. CPC A61C 19/063

(57) ABSTRACT

A chronic wound management apparatus fitted to at least some teeth of a patient's upper or lower arch is provided for the application of medications to the teeth and to adjacent gum tissue and for compression of said tissue for treatment of a chronic wound of the periodontal tissue. The apparatus includes at least one recess formed to conform to the teeth. A seal surrounds the recess at a location corresponding to the patient's gum line for applying pressure at the patient's gum line when the patient's teeth are disposed in the recess. A wound compression extension extends from the seal. Methods for treating chronic wounds of the periodontal tissue and for making the apparatus are also disclosed.

### CROSS REFERENCE TO RELATED APPLICATION

This application is claims the benefit and priority of U.S. Provisional Patent Application No. 62/749,312, filed on Oct. 23, 2018. The entire disclosures of the applications identified in this paragraph are incorporated herein by reference.

### FIELD

This disclosure relates to a chronic wound management apparatus for localized medication delivery and treatment of a chronic wound of the periodontal tissue.

### BACKGROUND

Periodontal pockets are a region susceptible to infection with a biofilm made up of many types of bacteria, but most commonly anaerobic, gram-negative bacteria are the predominant species in deeper periodontal pockets. The biofilms may cause tooth decay and gum disease. Conventional homecare, such as brushing and flossing, are usually incapable of removing the biofilm. Surgical intervention, such as with debridement or scaling and root planing, mechanically removes biofilm from the tooth surface, but does not remove all of the biofilm-forming bacteria. Following the mechanical stimulation, either with conventional home care or surgery, biofilm-causing bacteria significantly increase their reproductive capacity, resulting in rapid growth and regeneration of their biofilm.

The continued regrowth of the biofilm and host returning periodontal disease requires repeated personal and professional interventions. Thus, periodontal disease is a chronic wound which does not respond satisfactorily to acute disease treatments. Chronic wounds have a distinct microbiome, with a greater number of gram-negative anaerobes than those found in healthy tissue. It is desirable to provide a dental apparatus and method for treatment of periodontal disease that treats the disease as a chronic wound rather than as an acute problem. Successful management of chronic wounds include compressing the wounded tissue to reduce pro-inflammatory cytokines in the tissue, thereby reducing inflammation and edema. Wound compression also increases vascular and tissue oxygen levels and reduces capillary filtration.

U.S. Pat. No. 5,330,357 describes a method and system for treating periodontal disease by delivery of a medicament directly to an infected site via a dental floss, interdental brush, syringe, or a dental tray.

A periodontal medicament delivery tray and uses therefore is described in U.S. Pat. No. 6,966,773. This tray is made of elastomeric material having at least one recess to conform to the teeth and a raised seal surrounding the recess for applying a medicament to the patient's gum line. The recess may contain medication and a propulsion agent. The medication is forced into the periodontal pocket by the seal and mastication which presses the tray to release the medicament.

U.S. Pat. Nos. 8,956,161 and 9,326,837 and US PreGrant Publication No. 2016/0242883 disclose methods for treating oral biofilms, systemic diseases related to oral biofilms, and oral subgingival biofilms associated with systemic diseases, respectively, with a periodontal medicament delivery tray.

### SUMMARY

Accordingly, one embodiment provides a chronic wound management apparatus for localized medication delivery and wound compression and a method for treating a chronic wound of the periodontal tissue by providing a seal around each tooth or edentulous region associated with the affected area to guide or force medication onto the surface of the teeth and subgingivally into the infected area and compressing the wounded tissue.

Still another embodiment provides a chronic wound management apparatus and method of treatment that can be conveniently and easily implemented by the patient, without requiring special training or undue skill.

Yet another embodiment provides such chronic wound management apparatus and method of treatment that impedes deterioration of the bone and gums, and promotes regeneration of supporting structures around the patient's teeth.

Another embodiment is a method of treating a chronic wound of the periodontal tissue, the method comprises applying an antimicrobial agent to a subgingival portion of a tooth and the surrounding gingival tissue; this may also involve surgically removing bacteria associated with the chronic wound, and compressing the chronic wound.

In accordance with the disclosure, generally stated, an apparatus fitted to at least some teeth of a patient's upper or lower arch is provided for the application of medications to the teeth and to adjacent gum tissue and compression of the tissue for treatment of chronic wounds. The apparatus is constructed from resilient material molded to conform to the teeth and gum tissue. The apparatus includes at least one recess formed to conform to the teeth. A seal surrounds the recess at a location corresponding to the patient's gum line for applying pressure at the patient's gum line when the patient's teeth are disposed in the recess. A wound compression extension surrounds said raised seal which compresses the adjacent gum tissue. The seal and the length of the wound compression extension are modified to correspond to the disease state and are further modified to correspond to healing that occurs. The recess may contain a medication. Upon installation of the apparatus on the patient's teeth, the medication is forced onto the surface of the teeth and subgingivally by the seal into any pockets in the patient's gums proximate the teeth. If desired, a propulsion agent can be disposed within the recess such that upon application of the apparatus onto the patient's teeth, the propulsion agent generates pressure within the recess so as to positively force the medication onto the patient's teeth and into any of the pockets in the patient's gums proximate the teeth. The size of the seal and the wound compression extension enable the practitioner to manage the positive pressure environment and area of wound compression to correspond to the diseased state of the patient and to modify this environment as healing occurs.

### DETAILED DESCRIPTION

The following detailed description illustrates the present disclosure by way of example and not by way of limitation. This description will clearly enable one skilled in the art to make and use the embodiments, adaptations, variations, alternatives and uses of the disclosed apparatus and methods.

In one embodiment, a chronic wound management apparatus is contemplated. In this embodiment, the apparatus is for subgingivally delivering a medicament to an infected area or areas, such as a patient's gums, teeth, or gingival pockets and/or crevices. Bacteria can enter the epithelial attachment, periodontal ligaments, and/or supporting jaw or cortical bone through the gingival crevice. The apparatus directs a medicament to the chronic wound in the periodontal tissue via the raised seal. A periodontal tray having a recess and raised seal is generally described in U.S. Pat. No. 6,966,773, which is hereby incorporated by reference. The apparatus of the present disclosure further comprises a wound compression extension which compresses the gums to treat the infection as a chronic wound.

The chronic wound apparatus may be a precise form fitted flexible apparatus, preferably constructed from a moldable, resilient material, such as a suitable soft plastic elastomeric material. One such elastomeric material that works well for this purpose is a mouthguard material that comes in varying thickness from 1 mm to 3 mm thick. The apparatus may be molded as a replica of the original impression of the patient's teeth and periodontal tissue. In one embodiment, the molded body has a substantially U-shaped configuration that conforms to the shape of the patient's dentition and adjacent soft tissue structures. The tightness of fit of the seal or the wound compression extension can be adjusted by altering the patient's original impression to remove some portion of the gums on the patient's stone model of the teeth and gums, or on a digital image/model and molding the apparatus to the modified impression. An apparatus made from this impression may more tightly seal and/or compress the wound tissue.

In one embodiment, a person (e.g., a patient or professional) may apply an antimicrobial agent, an osteogenic agent, or other medicament or dental substance to the recess of the apparatus. A propulsion agent, such as a gel-based antiseptic cleanser including hydrogen peroxide or other medicament may also be added to the recess.

Those skilled in the art will understand that a wide range of medicaments and propulsion agents can be used. For example, propulsion agents could include, but are not limited to, any one of the following peroxide compounds: peroxyl, gly-oxide, carbamide peroxide, peroxide containing materials, or any other agent that will undergo status altering processes providing a change in ambient or localized pressure gradients. These medicaments can also be modified to correspond to the diseased status of the patient's tissues. Such peroxide based propulsion agents are preferably, but not necessarily in a gel-like state to allow for ease of application to the apparatus and to the teeth and gum surfaces. Examples of antimicrobial agents that may be used with this apparatus include any one or more of the following anti-infective agents: penicillin, cephalosporins, carbapenem, monobactams, chloramphenicol, quinolones, fluoroquinolones, tetracyclines, macrolides, spectinomycin, vancomycin, lincosamides, aminoglycosides, colistimethates, polymyxin, bacitracin, novobiocin, metronidazole, sulfonamides, nitrofurans, methenamines, and folate antagonists. In addition, well known antibiotic combinations may be used as well as antiviral, antiretroviral, immunologic agents, anti-infective agents, astringents, topical ointments or liniments, osteogenic modifying materials or other antibiotics. The patient can adjust the dosage or frequency of medicament delivery, as directed by the dentist or health care professional in accordance with the diseased status and also changes in the diseases status as healing occurs. These medicaments can be used to provide pressure to the chronic wound tissue to aid in edema management and other chronic wound treatment needs.

In one embodiment, the biofilm is analyzed by removing a sample from the affected tissue. The DNA of the bacteria comprising the biofilm can be analyzed to determine the bacterial species in the biofilm. The medication can be customized to address the particular bacterial populations in the biofilm.

In one embodiment, the patient then fits the apparatus onto the patient's appropriate arch, depending upon whether the apparatus is designed for the patient's upper or lower arch or both.

Using the apparatus to apply antibacterial or antimicrobial medicament to the site of infection subgingivally and compress the chronic wound impedes deterioration of the bone and gum and promotes healing and regeneration of the supporting bone structures around the patient's teeth. The apparatus can be modified or a new apparatus can be made to conform to the alterations in healing that occurs.

It is to be understood by one of ordinary skill in the art that the entire apparatus does not have to be formed entirely for a particular type of chronic wound or periodontal disease, but can have portions that are formed to accommodate one or more types and/or severities of chronic wound in various area of the mouth. For example, a patient who suffers from class IV periodontal disease in a particular area of the gums, but suffers from only class II periodontal disease in another region would be fitted with a chronic wound management apparatus that addresses the differential needs of the different types of wound.

Methods to treat infections of the periodontal tissue as an acute disease are generally described in U.S. Pat. Nos. 8,956,161 and 9,329,837 as well as US PreGrant Publication no. 2016/0242883, each of which are hereby incorporated by reference. One embodiment is directed to a method for treating a chronic wound of the periodontal tissue. In a particular embodiment, the acute treatment for periodontal infection further comprises compressing the infected tissues. In another embodiment, the method comprises applying an antimicrobial agent to a subgingival portion of a tooth and the surrounding gingival tissue, surgically removing bacteria associated with the chronic wound, and compressing the chronic wound. The antimicrobial agent may be applied via a periodontal tray that forms a seal with the gums adjacent to the chronic wound. Surgical removal of the bacteria may be performed by debridement or scaling and root planing. The chronic wound compression may be achieved with a chronic wound management apparatus as described above. In a particular embodiment, the method further includes administering a peroxide agent, such as hydrogen peroxide, or a colloidal hydrogen peroxide gel to the chronic wound. In another particular embodiment, the bacteria can be identified by nucleic acid (e.g., DNA or RNA) analysis. The artisan could then adjust the antimicrobial agent applied to the recess to be effective for treating the bacteria identified by the nucleic acid analysis.

The foregoing description is set forth only for illustrative purposes only and is not meant to be limiting. As various changes could be made in the above constructions without departing from the scope of the disclosure, it is intended that all matter contained in the above description or shown in the accompanying drawings shall be interpreted as illustrative and not in a limiting sense. Numerous variations, within the scope of the appended claims will be apparent to those skilled in the art in light of the foregoing description and accompanying drawings.

1. A chronic wound management apparatus fitted to at least one or more teeth of a patient's upper or lower arch for the application of medications to the teeth and to adjacent gum tissue and for compression of the adjacent gum tissue for treatment of periodontal disease,
said apparatus being of resilient elastomeric material molded to substantially conform to said teeth and gum tissue,
said apparatus having at least one recess formed to conform to the teeth,
a raised seal surrounding said recess corresponding to a location along the patient's gum line for applying along only the outer portion of the patient's gum line when the patient's teeth are disposed in the recess,
said recess containing a quantity of a medication and a propulsion agent such that upon installation of said apparatus on the patient's teeth the medication is forced onto the surface of the teeth and subgingivally by the seal into any pockets in the patient's gums proximate said teeth, and
a wound compression extension surrounding said raised seal wherein said wound compression extension compresses the adjacent gum tissue,
wherein the propulsion agent generates pressure within said recess so as to direct the medication onto the patient's teeth and into any of said pockets in the patient's gums proximate said teeth.

2. A chronic wound management apparatus for delivering a medicament subgingivally and compressing gingival tissue comprising a molded body that substantially conforms to at least a portion of a patient's dentition and adjacent gingival tissue, said body comprising
at least one recess formed therein that is adapted to snugly accommodate the crown portion of at least certain of the patient's teeth, wherein the recess contains a quantity of a medicament and a propulsion agent whereby said propulsion agent forces said medicament subgingivally by the seal and onto the patient's teeth
a raised seal projecting outwardly from said body and surrounding said recess at locations corresponding to only an outer portion of the patient's gum line proximate the patient's teeth, and
a wound compression extension extending from the raised seal corresponding to and compressing the gums.

3. A method for treating a chronic wound of the periodontal tissue in a subject in need thereof, said method comprising:
applying an antimicrobial agent to a subgingival portion of a tooth and surrounding gingival tissue with the periodontal tray;
surgically removing bacteria associated with the chronic wound; and
compressing the chronic wound,
wherein the method reduces at least one of edema or inflammation.
